(19) United States
(12) Patent Application Publication
(10) Pub. No.: US 2006/0132261 A1
(43) Pub. Date: Jun. 22, 2006

(54) Tm010 mode resonator, oscillator and transceiver

(76) Inventors: Tomiya Sonoda, Yokohama-shi (JP); Toshiro Hiratsuka, Machida-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/560,384

(22) PCT Filed: Jul. 5, 2004
(86) PCT No.: PCT/JP04/09539

§ 371 Date: Dec. 13, 2005

(30) Foreign Application Priority Data
Jul. 10, 2003 (JP) 2002-195212

(51) Int. Cl. H01P 1/213; H01P 7/10

(52) U.S. Cl. 333/134; 333/219.1

(57) ABSTRACT

To provide a TM010 mode resonator device, an oscillator device, and a transmission and reception device having radiation of an electromagnetic field suppressed and a high Q.

A TM010 mode resonator 2 having circular resonator electrodes 2A and 2B, opposite to each other, formed on the top surface 1A and bottom surface 1B of a dielectric substrate 1, respectively, is formed. Furthermore, in the dielectric substrate 1, a plurality of through holes 3 having no electrode on the inner wall surface 3A thereof are formed along the circular resonator electrodes 2A and 2B, and an open-circuited end is formed by these through holes 3. Thus, an electromagnetic field generated in the dielectric substrate 1 is reflected totally at the boundary between the through holes and the air, and radiation of the electromagnetic field can be suppressed.

### TECHNICAL FIELD

The present invention relates to a TM010 mode resonator device for oscillating a high-frequency electromagnetic wave of microwaves, millimeter waves, etc., an oscillator device, and a transmission and reception device.

### BACKGROUND ART

In general, a TM010 mode resonator device having circular electrodes, opposite to each other, formed on both surfaces of a dielectric substrate is known for use in transmission and reception devices, such as communication devices and radar devices. (see Patent Document 1, for example).

Patent Document: Japanese Unexamined Patent application Publication No.10-98316

In such a TM010 mode oscillator device according to the prior art, when compared with a TM01 mode resonator device in which a grounding electrode is formed on the substantially whole bottom surface of the dielectric substrate, since the thickness of the dielectric substrate can be increased about double the thickness of a substrate where the coupling to an electromagnetic field of a TM0 mode as a surface wave mode does not occur, about twice as large a conductor Q (Qc) and no load Q (Qo) can be obtained and a low loss filter becomes possible.

Now, in the above TM010 mode resonator device of the prior art, when Q (quality factor) is heightened by increasing the thickness of the dielectric substrate, an electromagnetic field in the dielectric substrate is coupled to a TM0 mode and distributed as a radiation mode. Because of this, the energy concentration in the dielectric substrate is lowered and, since Q is inversely deteriorated by the radiation loss, there is a problem in that the effect of increasing the conductor Q (Qc) by increasing the thickness is offset.

### DISCLOSURE OF INVENTION

The present invention has been made in consideration of the above problem of the prior art, and it is an object of the present invention to provide a TM010 mode resonator device, an oscillator device, and a transmission and reception device suppressing radiation of an electromagnetic field and having a high Q.

In order to solve the above problem, according to the present invention of claim 1, a TM010 mode resonator device comprises a dielectric substrate; electrodes formed on both surfaces of the dielectric substrate, at least one of the electrodes being a circular electrode; and a plurality of through holes passing through the dielectric substrate and formed around the circular electrode in the dielectric substrate, the inside of each through hole having no electrode as no electrode-formed portion. In the TM010 mode resonator device, an open-circuited end for improving confinement of an electromagnetic field is provided around the circular electrode by using the plurality of through holes.

Under such a construction, an electromagnetic field is generated by resonance in the portion corresponding to the circular electrode in the dielectric substrate and the electromagnetic field can be reflected totally by using the open-circuited end. Accordingly, it is able to improve no load Q by suppressing radiation of the electromagnetic field and the energy confinement can be heightened.

Furthermore, in the present invention, a plurality of through holes passing through the dielectric substrate are formed around the circular electrode in the dielectric substrate, the inside of each through hole having no electrode is made no electrode-formed portion, and the open-circuited end is formed by the plurality of through holes.

Thus, since air is filled in the through holes, the electromagnetic field can be reflected totally at the boundary between the inner wall surface of the through holes and the air and the generated electromagnetic field can be confined in the portion corresponding to the circular electrode in the dielectric substrate.

In the present invention, it is desirable that, when the wavelength of a resonance frequency in the dielectric substrate is represented by λg, the space between neighboring through holes be λg/4 or less. Thus, it is able to prevent an electromagnetic field from leaking from between neighboring through holes and the energy confinement can be heightened.

Furthermore, in the present invention, a TM010 mode resonator device comprises a dielectric substrate; electrodes formed on both surfaces of the dielectric substrate, at least one of the electrodes being a circular electrode; and a plurality of strip electrodes disposed so as to radially extend around the circular electrodes formed on both surfaces or the circular electrode formed on one surface of the dielectric substrate so as to have a space between the circular electrodes or the circular electrode and the plurality of strip electrodes.

In this case, when the wavelength of a resonance frequency of the dielectric substrate is represented by λg, by setting the lengths of the strip electrodes at λg/4, for example, the tip portion (side of the outermost end) of each strip electrode can be short-circuited in a pseudo way. Alternatively, by setting the length of the strip electrodes at λg/2, for example, the tip side of each strip electrode can be open-circuited in a pseudo way. At this time, since the circular electrode is enclosed by a plurality of radially disposed strip electrodes, it is able to make an electromagnetic field generated in the portion corresponding to the circular electrode in the dielectric substrate reflected totally at the tip side of the strip electrodes as a short-circuited end or an open-circuited end, and the energy confinement can be heightened. As a result, even if the thickness of the dielectric substrate is increased, since radiation of an electromagnetic field can be suppressed, it is able to simultaneously improve the conductor Q and the radiation Q and to effectively heighten no load Q.

In the present invention it is desirable that, when the wavelength of a resonance frequency is represented by λg, the radially extending length of the strip electrodes be λg/4 and the strip electrodes be rectangular in shape.

Thus, the tip side (side of the outermost end) of each strip electrode can be short-circuited in a pseudo way. Accordingly, an electromagnetic field generated in the portion corresponding to the circular electrode in the dielectric substrate can be reflected totally at the tip side of the strip electrodes as a short-circuited end and the energy confinement can be heightened.

In the present invention, it is desirable that the space between neighboring strip electrodes be set to be λg/4 or less. Thus, it is able to prevent an electromagnetic field from leaking from between neighboring strip electrodes and to heighten the energy confinement.

Furthermore, an oscillator device may be constituted by using a TM010 mode resonator according to the present invention and also a transmission and reception device, such as a radar device and communication device, by using an oscillator device according to the present invention.

When an oscillator device and a transmission and reception device are constituted by using a TM010 mode resonator device according to the present invention, the structure of the oscillator device, etc., can be simplified and also the manufacturing cost of the whole communication device can be reduced.

### BRIEF DESCRIPTION OF THE DRAWINGS

FIG. 1 is a perspective view showing a TM010 mode resonator device according to a first embodiment.

FIG. 2 is a top view showing the TM010 mode resonator device in FIG. 1.

FIG. 3 is a sectional view of the TM010 mode resonator device taken on line III-III of FIG. 2.

FIG. 4 is a perspective view showing a TM010 mode resonator device according to a second embodiment.

FIG. 5 is a top view showing the TM010 mode resonator device in FIG. 4.

FIG. 6 is an enlarged top view of an essential part, a strip electrode at location a in FIG. 5.

FIG. 7 is a perspective view showing the TM010 mode resonator device according to a second embodiment housed in a cavity.

FIG. 8 is characteristic lines showing the relation between the space height from the TM010 mode resonator device in FIG. 7 to the cavity and the coefficient of variation of the resonance frequency.

FIG. 9 is an enlarged top view of an essential part, at the same position as that in FIG. 6, a strip electrode of a first modified example.

FIG. 10 is an enlarged top view of an essential part, at the same position as that in FIG. 6, a strip electrode of a second modified example.

FIG. 11 is an enlarged top view of an essential part, at the same position as that in FIG. 6, a strip electrode of a third modified example.

FIG. 12 is an enlarged top view of an essential part, at the same position as that in FIG. 6, a strip electrode of a fourth modified example.

FIG. 13 is an enlarged top view of an essential part, at the same position as that in FIG. 6, a strip electrode of a fifth modified example.

FIG. 14 is an enlarged top view of an essential part, at the same position as that in FIG. 6, a strip electrode of a sixth modified example.

FIG. 15 is an enlarged top view of an essential part, at the same position as that in FIG. 6, a strip electrode of a seventh modified example.

FIG. 16 is a top view showing a TM010 mode resonator device according to a third embodiment.

FIG. 17 is an enlarged top view of an essential part, a strip electrode at location b in FIG. 16.

FIG. 18 is an enlarged top view of an essential part, at the same position as that in FIG. 17, a strip electrode of an eighth modified example.

FIG. 19 is an enlarged top view of an essential part, at the same position as that in FIG. 17, a strip electrode of a ninth modified example.

FIG. 20 is a top view showing an oscillator device according to a fourth embodiment.

FIG. 21 is an electric circuit diagram of the oscillator device in FIG. 20.

FIG. 22 is a block diagram showing a communication device according to a fifth embodiment.

### REFERENCE NUMERALS

1, and 11 dielectric substrates
2, and 12 TM010 mode resonators
2A, 2B, 12A, and 12B resonator electrodes (circular electrodes)
3 through hole
13, 14, 21-27, and 31-33 strip electrodes
56 TM010 mode resonator device
61 communication device (transmission and reception device)
76 oscillator device

### BEST MODE FOR CARRYING OUT THE INVENTION

Hereinafter, an oscillator device and a communication device according to embodiments of the present invention are described in detail with reference to the accompanying drawings.

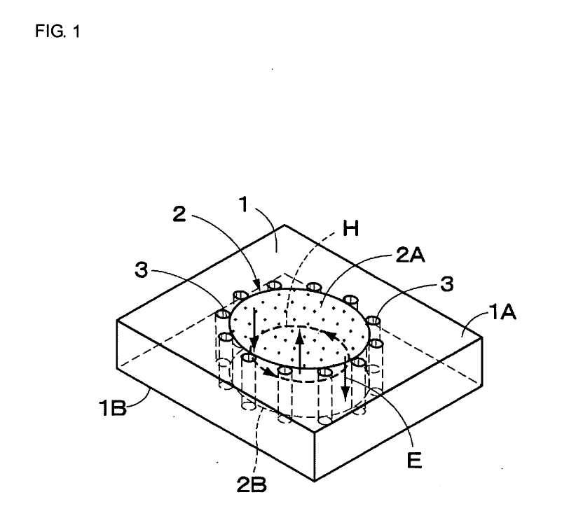

First, FIGS. 1 to 3 show a TM010 mode resonator device according to a first embodiment. In the drawings, reference numeral 1 represents a dielectric substrate constituting the main body of a TM010 mode resonator device and the dielectric substrate 1 is formed by using a ceramic material having a dielectric constant εr of about 24 (εr≈24), for example. Furthermore, the dielectric substrate 1 is made of a substantially square flat plate, for example, and constitutes a small piece of plate having an area which is a size larger than resonator electrodes 2A and 2B to be described later.

Reference numeral 2 represents a TM010 mode resonator formed in the middle of the dielectric substrate 1 and the TM010 mode resonator 2 contains resonator electrodes 2A and 2B made of circular electrodes which are located in the middle of the dielectric substrate 1 and formed on the top surface 1A and bottom surface 1B, respectively. Furthermore, the resonator electrodes 2A and 2B are formed by using a conductive thin film of a metal material, etc., and disposed at opposite locations so as to form a substantially cylindrical form, and then, the diameter D is set to be a value according to the wavelength λg of the resonance frequency in the dielectric substrate 1 (D=λg, for example).

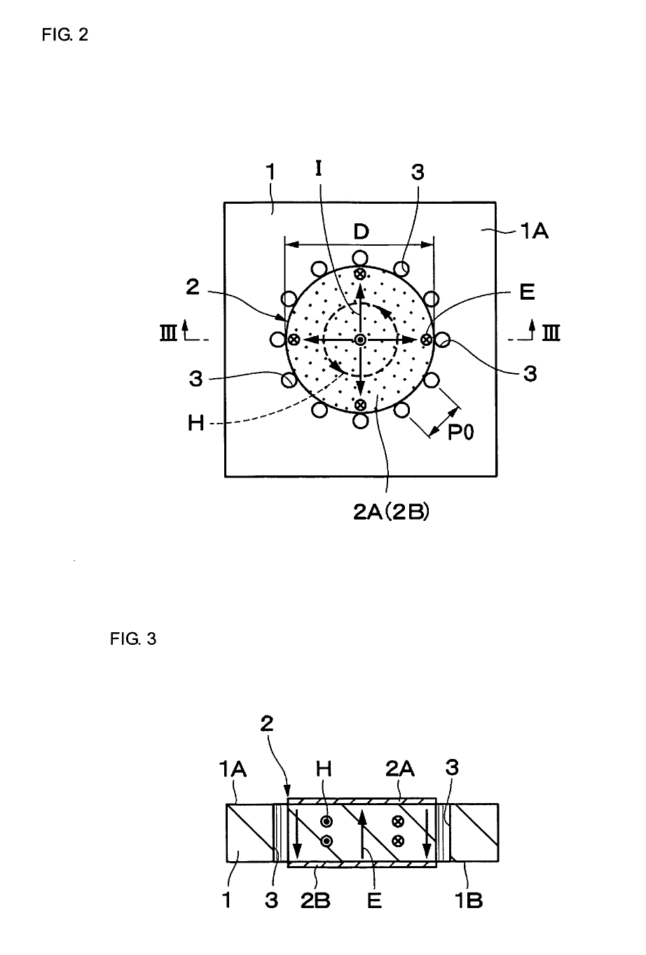

Then, an electric field E extending in the thickness direction of the dielectric substrate 1 between the resonator electrodes 2A and 2B is generated in the dielectric substrate 1 and simultaneously a magnetic field H which is concentric around the central position of the resonator electrodes 2A and 2B is generated (see FIGS. 2 and 3). Furthermore, in the resonator electrodes 2A and 2B, a current I flows along the radiation direction between the central position and the outer periphery.

Reference numeral 3 represents a plurality (twelve, for example) of through holes formed along the periphery of the resonator electrodes 2A and 2B so as to pass through the dielectric substrate 1, and the inner wall surface 3A (inner portion) of each through hole is no electrode-formed portion where no electrode is contained. Furthermore, the space P0 (pitch) between neighboring through holes 3 is set to be ¼ or less of the wavelength λg of the resonance frequency in the dielectric substrate 1 (P0≦λg/4). Then, the plurality of through holes 3 are disposed so as to enclose the resonator electrodes 2A and 2B and the through holes 3 form an open-circuited end as a whole.

The TM010 mode resonator device of the present embodiment has the above-described structure and, when the TM010 mode resonator 2 operates, electric fields E in opposite directions to each other are formed at the central position of the resonator electrodes 2A and 2B and at the outer peripheral position, and a magnetic field concentric around the central position of the resonator electrodes 2A and 2B is formed. Thus, the TM010 mode resonator 2 resonates at a frequency in which the diameter D of the resonator electrodes 2A and 2B is one wavelength.

However, the TM010 mode itself is generally a radiation mode, and there are many cases in which such a characteristic is utilized in applications such as antennas, etc. However, when the resonator device is used as a TM010 mode resonator 2, there is a problem in that, since the radiation is large, the radiation loss deteriorates and no load Q (Qo) is also worsened.

In contrast to that, in the present embodiment, since the plurality of through holes where the electrode of the inner wall surface 3A is omitted is formed along the periphery of the resonator electrodes 2A and 2B of the dielectric substrate 1, the total reflection of an electromagnetic field generated between the resonator electrodes 2A and 2B can be performed at the boundary between the inner wall surface 3A of the through holes 3 and the air. As a result, it is able to suppress the radiation of an electromagnetic field and heighten no load Q (Qo), and also it is able to improve the energy confinement.

Furthermore, since the space P0 between neighboring through holes 3 is set to be ¼ or less of the wavelength λg of the resonance frequency, it is able to present an electromagnetic field from leaking from between neighboring through holes 3 and to increase the confinement of the electromagnetic field.

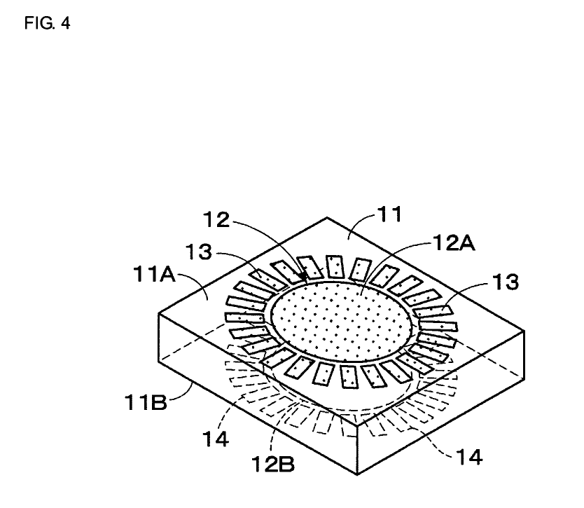

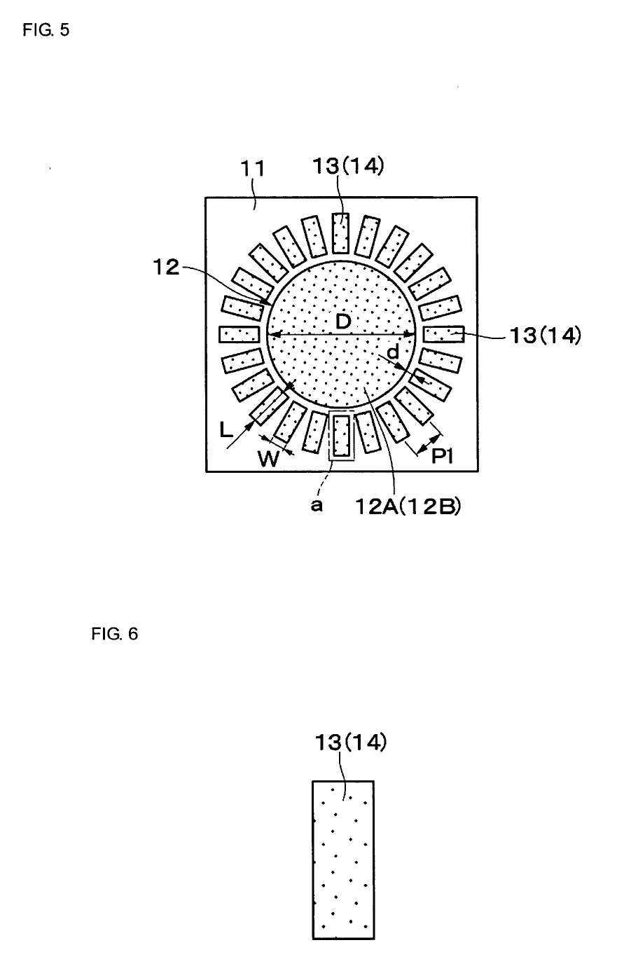

Next, a TM010 mode resonator device according to a second embodiment is shown in FIGS. 4 to 6. The present embodiment is characterized in that a plurality of strip electrodes enclosing the resonator electrodes are disposed so as to radially extend on both surfaces of the dielectric substrate.

Reference numeral 11 represents a dielectric substrate substantially the same as the dielectric substrate 1 of the first embodiment, and the dielectric substrate 11 is formed so as to be a substantially square flat plate by using a ceramic material having a dielectric constant εr of 25 (εr=25), for example.

Reference numeral 12 represents a TM010 mode resonator formed in the middle of the dielectric substrate 11, and, substantially in the same way as the TM010 mode resonator 2 of the first embodiment, the TM010 mode resonator 12 contains resonator electrodes 12A and 12B made of circular electrodes which are located in the middle of the dielectric substrate 11 and formed on the top surface 11A and bottom surface 11B, respectively. Furthermore, the resonator electrodes 12A and 12B are formed by using a conductive thin film and disposed at opposite locations to each other, and then, the diameter D is set to be a value according to the wavelength λg of the resonance frequency in the dielectric substrate 11 (D=λg, for example).

Then, the central position and external peripheral position of the resonator electrodes 12A and 12B are made open-circuited in a pseudo way and electric fields in opposite direction to each other are generated at these portions. Furthermore, a magnetic field which is concentric around the central position of the resonator electrodes 2A and 2B is generated between the resonator electrodes 12A and 12B. Thus, a frequency in which the diameter D of the resonator electrodes 12A and 12B is one wavelength resonates with the TM010 mode resonator 12.

Reference numerals 13 and 14 represent pluralities of strip electrodes enclosing the resonator electrodes 12A and 12B formed on the top surface 11A and bottom surface 11B of the dielectric substrate 11, respectively, and the plurality (24, for example) of strip electrodes 13 which are radially extend are disposed around the resonator electrodes 12A so as to have a fixed minute space of a dimension d (d≈50 μm, for example) between the strip electrodes 13 and the resonator electrodes 12A. In the same way, the plurality of strip electrodes 14 which are radially extend are disposed around the resonator electrode 12B so as to have a fixed space of a dimension d between the strip electrodes 14 and the resonator electrode 12B.

Furthermore, each of the strip electrodes 13 and 14 is substantially rectangular and the radially extending length L of the electrodes is set to be a value of about ¼ of the wavelength λg pf the resonance frequency (L=λg/4). Thus, since the tip side (side of the outermost end) of the strip electrodes 13 and 14 is short-circuited in a pseudo way, and an annular ring-shaped short-circuited end in which the TM010 mode resonator 12 is enclosed by the pluralities of strip electrodes 13 and 14 can be formed.

Moreover, on the tip side of the strip electrodes 13, the space P1 (pitch) between neighboring strip electrodes 13 separated in the circumferential direction is set to be ¼ or less of the wavelength λg of the resonance frequency (P1≦λg/4). In the same way, also on the tip side of the strip electrodes 14, the space P1 (pitch) between neighboring strip electrodes 14 is set to be ¼ or less of the wavelength (P1≦λg/4).

Moreover, the strip electrodes 13 and 14 may be disposed at positions opposite to each other or positions displaced in the circumferential direction so as to sandwich the dielectric substrate 11. Furthermore, the numbers of the strip electrodes 13 and 14 may be the same or different from each other.

The TM010 mode resonator device of the present embodiment has the above-described structure and the basic operation of the TM010 mode resonator 12 is not different from the TM010 mode resonator 2 of the first embodiment.

Here, in order to improve no load Q (Qo) of the TM010 mode resonator 12, there is a method of increasing the thickness of the dielectric substrate 11 in addition to a method of decreasing the radiation loss. This is because the conductor Q (Qc) is represented by the ratio of the thickness t of the dielectric substrate 11 to the skin depth δ (Qc=t/δ). For example, when the thickness t of the dielectric substrate 11 is 0.6 mm (t=0.6 mm) and the skin depth a is 0.6 μm (δ=0.6 μm), the conductor Q (Qc) becomes 1000 (Qc=1000). In this way, when the thickness t of the dielectric substrate 11 increases, it is able to improve the conductor Q (Qc), but, in contrast with this, there is a tendency to increase the radiation loss.

As a result, even if the dielectric substrate 11 is formed like a chip, for example, and the end face is made open-circuited, when the thickness of the dielectric substrate 11 is increased, there is a problem in that the energy confinement is worsened because of radiation.

Contrary to this, in the present embodiment, since pluralities of strip electrodes 13 and 14 radially extending so as to enclose the resonator electrodes 12A and 12B are formed on the top surface 11A and bottom surface 11B of the dielectric substrate 11, the tip sides of the strip electrodes 13 and 14 is short-circuited in a pseudo way and the electric field can be concentrated between the resonator electrodes 12A and 12B. Because of this, in the present embodiment, a magnetic field energy can be confined and the radiation of an electromagnetic field can be suppressed.

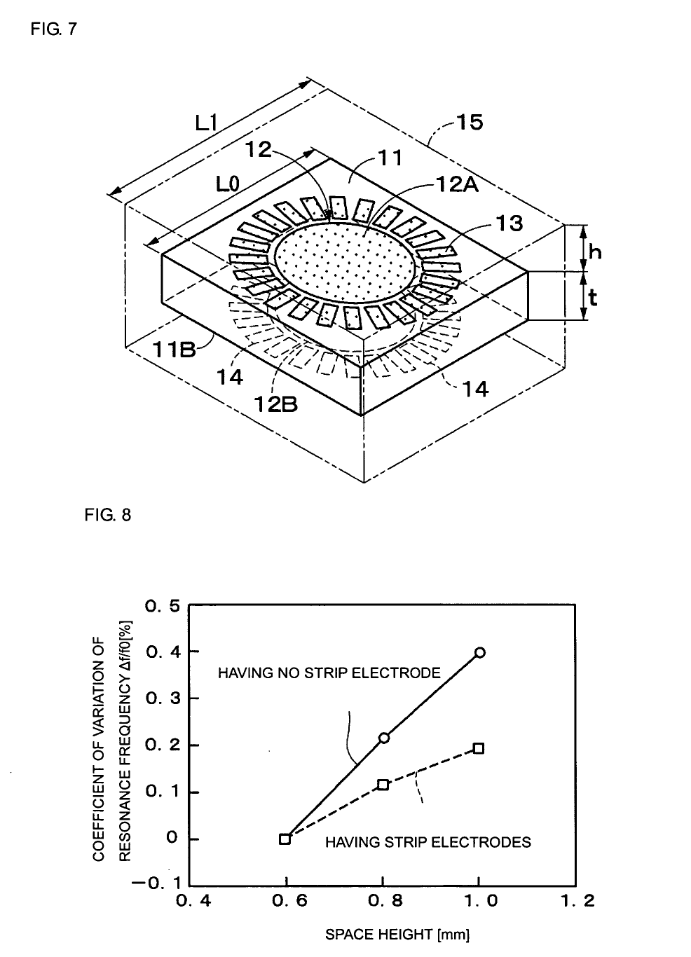

In order to confirm the effect of suppression of radiation by such strip electrodes 13 and 14, the cases in which a resonator device having strip electrodes 13 and 14 and a resonator device not having strip electrodes 13 and 14 are contained inside a cavity 15 of a substantially square box-like space, respectively, were assumed (see FIG. 7). In each resonator device, the coefficient of variation Δf/f0 of a resonance frequency when the space height of the upper portion of the cavity 15 (side of the top surface 11A of the dielectric substrate 11) was changed was calculated by using a three-dimensional electromagnetic field simulation. The result is shown in FIG. 8.

Moreover, the result in FIG. 8 was calculated under the assumption that the resonance frequency f0 is 38 GHz (f0=38 GHz), the dielectric constant of the dielectric substrate 11 εr is 25 (εr=25), the thickness of the dielectric substrate 11 is 0.6 mm (t=0.6 mm), the length L0 of one side of the substantially square dielectric substrate 11 is 2.5 mm (L0=2.5 mm), the diameter D of the resonator electrodes 12A and 12B is 1.6 mm (D=1.6 mm), the length L of the strip electrodes 13 and 14 is 0.23 mm (L=0.23 mm), the width W of the strip electrodes 13 and 14 is 0.1 mm (W=0.1 mm), the number of the strip electrodes 13 and 14 is 24, the space d between the resonator electrodes 12A and 12B and the strip electrodes 13 and 14 is 50 μm (d=50 μm), and the length L1 of one side of the substantially square cavity 15 is 3 mm (L1=3 mm).

Furthermore, the dielectric substrate 11 is disposed in the middle of the cavity 15 so as to be floated. Practically, the dielectric substrate 11 is disposed on a support made of a low dielectric material so as not to affect the resonance characteristics of the TM010 mode resonator 12.

From the result in FIG. 8, when strip electrodes 13 and 14 are formed as in the present embodiment, when compared with the case in which the strip electrodes 13 and 14 are eliminated, it is understood that the variation of the resonance frequency F0 is small even if the height h of the space of the cavity 15 is changed. That is, since the radiation of an electromagnetic field in the case where the strip electrodes 13 and 14 are formed is smaller than in the case where the strip electrodes are eliminated, it is understood that the effect of the cavity 15 is little and it was able to confirm the effect of suppression of radiation by the strip electrodes 13 and 14.

In this way, in the present embodiment, since pluralities of strip electrodes 13 and 14 radially extending so as to enclose the resonator electrodes 12A and 12B are formed on the top surface 11A and bottom surface 11B of the dielectric substrate 11, the tip side of each of the strip electrodes 13 and 14 can be short-circuited in a pseudo way by setting the length L of the strip electrodes 13 and 14 at one fourth of the wavelength λg of the resonance frequency. At this time, since the resonator electrodes 12A and 12B are enclosed by the pluralities of strip electrodes 13 and 14 disposed so as to radially extend, the total reflection of an electromagnetic field generated between the resonator electrodes 12A and 12B can be performed on the short-circuited tip side of the strip electrodes 13 and 14.

As a result, even if the thickness of the dielectric substrate 11 is increased, since the radiation of an electromagnetic field between the resonator electrodes 12A and 12B can be suppressed, both conductor Q (Qc) and radiation Q (Qr) can be simultaneously improved and it is able to heighten no load Q (Qo) of the TM010 mode resonator 12.

Furthermore, since the space P1 between neighboring strip electrodes 13 and 14 is set to be ¼ or less of the wavelength λg of the resonance frequency (P1≦λg/4), it is able to prevent an electromagnetic field from leaking from between neighboring strip electrodes 13 and 14 and to increase the energy confinement.

Moreover, in the second embodiment, the length L of strip electrodes 13 and 14 is set to be ¼ of the wavelength of the resonance frequency and the tip side of strip electrodes 13 and 14 is open-circuited in a pseudo way. However, the present invention is not limited to this, and, for example, the length of strip electrodes is set to be one half of the wavelength λg of the resonance frequency and the tip side of strip electrodes may be open-circuited in a pseudo way. Furthermore, the length of strip electrodes are not limited to these and the tip side may be short-circuited or open-circuited in a pseudo way.

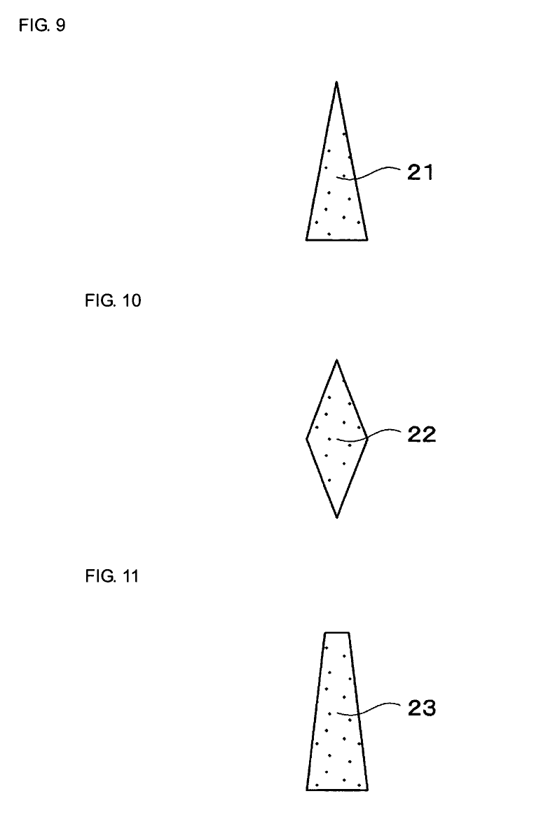

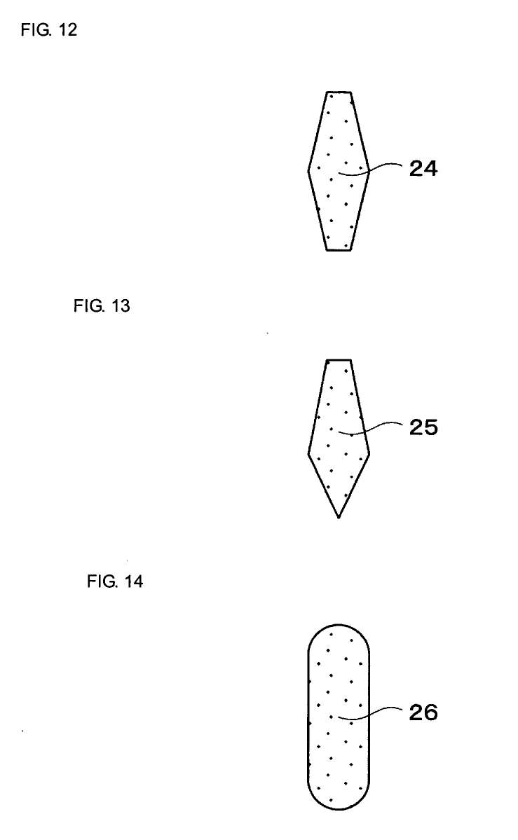

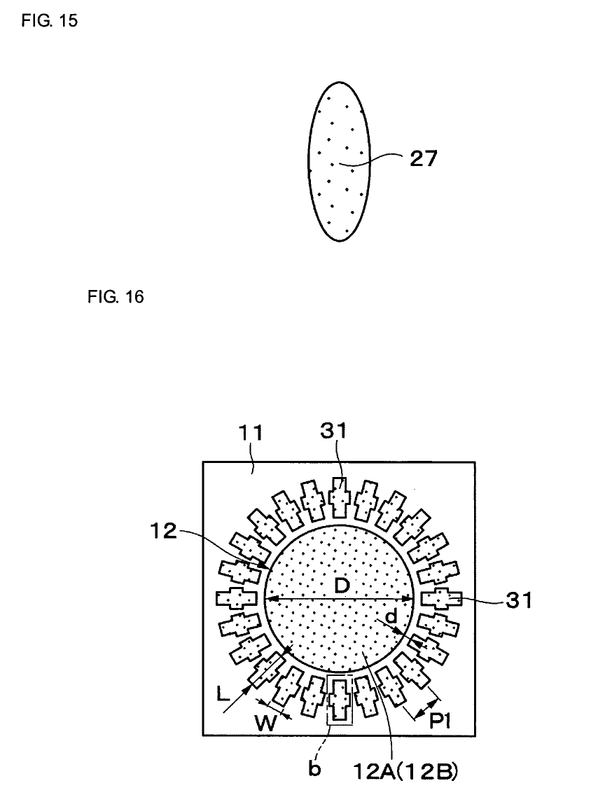

Furthermore, in the second embodiment, strip electrodes 13 and 14 of a substantially rectangular shape are used. However, the present invention is not limited to these, and, for example, as in first to seventh modified examples shown in FIGS. 9 to 15, substantially triangular strip electrodes 21, substantially rhombic strip electrodes 22, substantially trapezoidal strip electrodes 23, substantially hexagonal strip electrodes 24, substantially pentagonal strip electrodes 25, substantially long-hole strip electrodes 26 both ends of which are circular, substantially oval strip electrodes 27, etc., may be used.

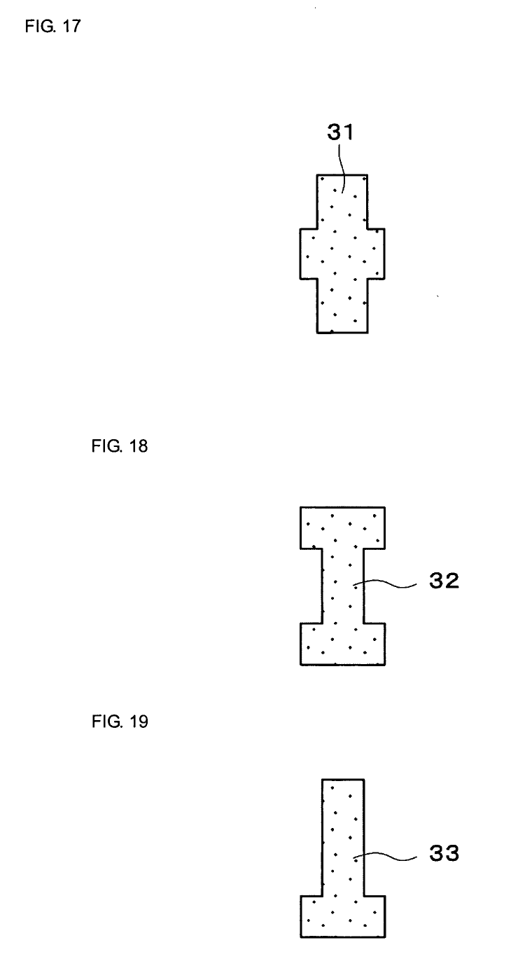

Next, FIGS. 16 and 17 show a TM010 mode resonator device according to a third embodiment and the present embodiment is characterized in that strip electrodes are of a stepped impedance type in which the impedance changes in a stepwise manner in the middle of the length direction of the strip electrodes. Moreover, in the present embodiment, the same reference numerals are given the same components as in the second embodiment and their description is omitted.

Reference numeral 31 represents strip electrodes on the top surface 11A and bottom surface 11B of the dielectric substrate 11 so as to enclose the resonator electrodes 12A and 12B. Substantially in the same way as in the strip electrodes 13 and 14 of the second embodiment, a fixed space having a minute space d is formed between the strip electrodes 31 and the resonator electrodes 12A and 12B, and a plurality, 24, for example, of strip electrodes 31 are disposed so as to radially extend.

Furthermore, the strip electrodes 31 in which the middle in the length direction is widened and both ends are narrowed are substantially cross-shaped. In the strip electrodes 31, the impedance in the length direction changes in a step-wise manner and the tip side (side of the outermost end) of the strip electrodes 31 is short-circuited in a pseudo way. Thus, substantially in the same way as in the strip electrodes 13 and 14 of the second embodiment, in a plurality of strip electrodes 31, a ring-shaped short-circuited end enclosing the TM010 mode resonator 12 is formed. Moreover, at the tip side of the strip electrodes 31, the space P1 (pitch) between neighboring strip electrodes 31, which are separated from each other in the circumferential direction, is set to be ¼ or less of the wavelength of the resonance frequency (P1≦λg/4).

Moreover, the strip electrodes 31 may be disposed at opposite positions to each other or at positions displaced in the circumferential direction so as to sandwich the dielectric substrate 11. Furthermore, the numbers of strip electrodes 31 may be the same or different from each other.

The TM010 mode resonator device of the present embodiment has the above construction and the basic operation of the TM010 mode resonator 12 is not different from that of the TM010 mode resonator 12 according to the second embodiment.

However, in the present embodiment, since the substantially cross-shaped strip electrodes 31 in which the impedance changes in a step-wise manner in the middle of the length direction are used, when compared with the case where substantially square strip electrodes 13 and 14 are used as in the second embodiment, for example, the dimension in the length direction can be reduced. Accordingly, the whole resonator device can be reduced in size.

Moreover, in the third embodiment, substantially cross-shaped strip electrodes 31 are used as a stepped impedance type. However, the present invention is not limited to this, and, for example, as in the eighth modified example shown in FIG. 18, substantially dumbbell-shaped strip electrodes 32 in which both ends in the length direction are widened and the middle is narrowed may be used. Furthermore, as in the ninth modified example shown in FIG. 19, for example, substantially T-shaped strip electrodes 33 in which one end in the length direction is widened and the other end is narrowed may be used.

Furthermore, in the second and third embodiments, the strip electrodes 13, 14, 21 to 27, and 31 to 33 are formed on both of the top surface 11A and bottom surface 11B of the dielectric substrate 11. However, the present invention is not limited these, and, for example, strip electrodes may be formed only on either of the top surface and bottom surface of a dielectric substrate. In this case, it is considered that the effect of radiation suppression of an electromagnetic field is reduced by half.

Moreover, in the first to third embodiments, both of the resonator electrodes 2A, 2B, 12A, and 12B of the TM010 mode resonators 2 and 12 are formed so as to be in a circular shape, but if either of them is in a circular shape, it is sufficient.

Furthermore, in the first to third embodiments, the dielectric substrates 1 and 11 of the TM010 mode resonator devices are square-shaped, but they may be of another shape such as of a circular shape, oval shape, etc., for example.

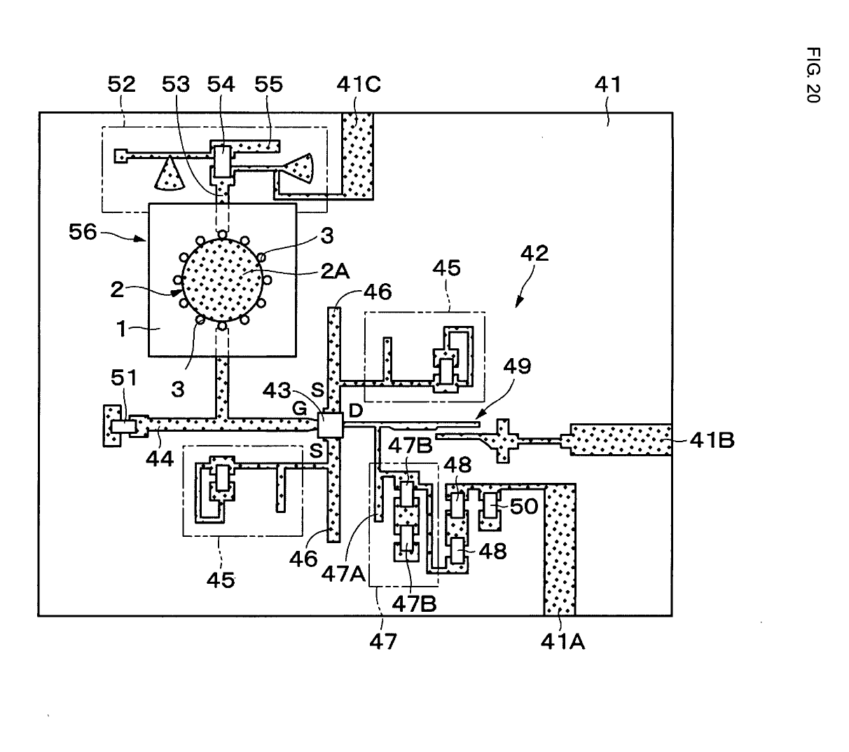

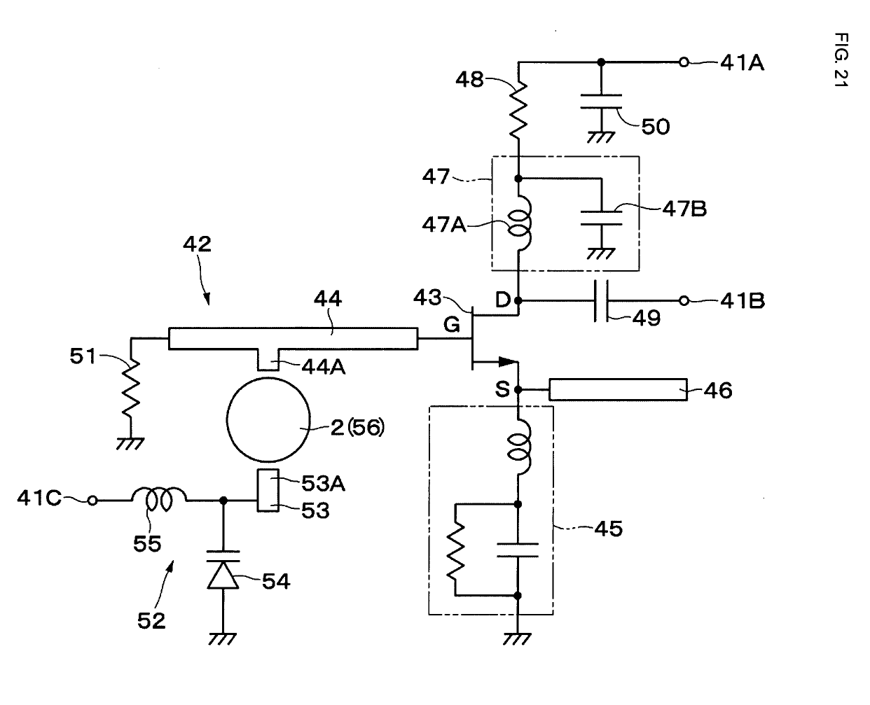

Next, FIGS. 20 and 21 show a fourth embodiment of the present invention, and the present embodiment is characterized in that an oscillator device is constituted by using a TM010 mode resonator device. Moreover, in the present embodiment, the same reference numerals are given the same components as in the first embodiment and their description is omitted.

Reference numeral 41 represents an oscillation circuit substrate made of a dielectric material, and the oscillation circuit substrate 41 is formed by using a ceramic material, resin material, etc., having a lower dielectric constant compared with the dielectric substrate 1 of the TM010 mode resonator 56, for example, and is of a substantially square flat plate.

Reference numeral 42 represents an oscillation circuit portion formed on the surface of the oscillation circuit substrate 41, and the oscillation circuit portion 42 contains a field-effect transistor 43 (hereinafter, referred to as an FET 43), a microstrip line 44, a bias circuit 45, etc. Then, a power-supply voltage is supplied to the oscillation circuit portion 42 through a power supply terminal 41A, a signal of a fixed oscillation frequency set by the TM010 mode resonator 2, and the signal is output through an output terminal 41B.

Here, the gate terminal G of the FET 43 is connected to the base terminal side of the microstrip line 44. Furthermore, the source terminal S of the FET 43 is connected to the bias circuit 45 on the source side and to an inductive stub 46 as an inductor for controlling the feedback frequency.

On the other hand, the drain terminal D of the FET 43 is connected to the power supply terminal 41 A through a filter circuit 47 made up of an inductive stub 47A and a capacitor 47B, and a bias resistor 48, and connected to the output terminal 41B through a coupled line 49 for cutting off a DC component. Furthermore, a capacitor 50 for surge elimination is connected to the power supply terminal 41A.

Moreover, a terminating resistor 51 is connected to the tip side of the microstrip line 44; the microstrip line 44 has a branch circuit branching substantially in a T shape in the middle of the length direction, and one side of the branch circuit as an excitation electrode 44A for exciting the TM010 mode resonator 2 extends toward the dielectric substrate 1.

Reference numeral 52 represents a frequency control circuit formed on the surface of the oscillation circuit substrate 41, and the frequency control circuit 52 is disposed on the opposite side of the oscillation circuit 42 so as to sandwich the dielectric substrate 1. Furthermore, the frequency control circuit 52 is basically constituted by a microstrip line 53 one end of which is disposed in the vicinity of the TM010 mode resonator 2 and a variable capacitance diode 54 (varactor diode) as a modulation element connected to the other end of the microstrip line 53.

Here, the cathode terminal of the variable capacitance diode 54 is connected to the microstrip line 53 and the anode terminal is grounded. Furthermore, a control input terminal 41C is connected to the cathode terminal of the variable capacitance diode 54 through an inductive stub 55 as a choke coil. Moreover, the tip side of the microstrip line 53 constitutes an excitation electrode 53A for exciting the TM010 mode resonator 2.

Then, the frequency control circuit 52 makes the capacitance of the variable capacitance diode 54 change in accordance with the control voltage applied to the control input terminal 41C to control the oscillation frequency (resonance frequency).

Reference numeral 56 represents the TM010 mode resonator device according to the first embodiment formed between the oscillation circuit 42 and the frequency control circuit 52, and the dielectric substrate 1 of the TM010 mode resonator device 56 is mounted on the top surface of the oscillation circuit substrate 41 between the oscillation circuit 42 and the frequency control circuit 52.

Furthermore, the resonator electrode 2B formed on the bottom surface of the dielectric substrate 1 out of the resonator electrodes 2A and 2B of the TM010 mode resonator is grounded through the land (not illustrated) formed on the top surface of the oscillation circuit substrate 41, etc. Then, the TM010 mode resonator 2 is connected to the oscillation circuit 42 and the frequency control circuit 52 through the excitation electrodes 44A and 53A of the microstrip lines 44 and 53.

The oscillator device of the present embodiment has the above construction, and next, the operation is described.

When the drive voltage is applied to the power supply terminal 41A, a signal in accordance with the resonance frequency of the TM010 mode resonator 2 is input to the gate terminal G of the FET 43. Thus, since the oscillation circuit 42 and the TM010 mode resonator device 56 constitute a band reflection type oscillation circuit, the FET 43 amplifies the signal in accordance with the resonance frequency of the TM010 mode resonator 2 and outputs the amplified signal to the outside through the output terminal 41B.

Furthermore, since the frequency control circuit 52 having the variable capacitance diode 54 is connected to the TM010 mode resonator device 56, it is able to make the resonance frequency of the TM010 mode resonator 2 variable in accordance with the value of the control voltage applied to the control input terminal 41C. In this way, the whole oscillator device functions as a voltage control oscillator (VCO).

Thus, in the present embodiment, since the oscillator device is constituted by using the TM010 mode resonator device 56 according to the first embodiment, it is able to suppress radiation of the electromagnetic field of the TM010 mode resonator 2 to the outside, and a cavity enclosing the TM010 mode resonator device 56 can be eliminated, for example. Because of this, the oscillator device can be made lower in height and simplified, and, as a result, the manufacturing cost can be reduced.

Moreover, in the fourth embodiment, although the TM010 mode resonator device of the first embodiment is used as the TM010 mode resonator device 56, also the TM010 mode resonator device of the second or third embodiment may be used.

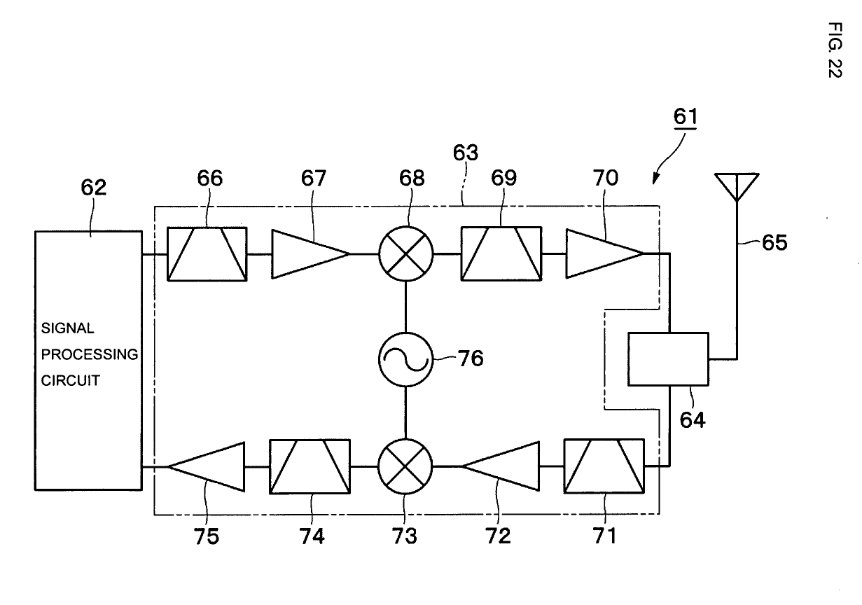

Next, FIG. 22 shows a fifth embodiment of the present invention, and the present embodiment is characterized in that a communication device as a transmission and reception device is constituted by using an oscillation device having a TM010 mode resonator device of the present invention.

Reference numeral 61 represents a communication device according to the present embodiment, and the communication device 61 is constituted by a signal processing circuit 62, a high-frequency module for outputting or inputting a high-frequency signal which is connected to the signal processing circuit 62, and an antenna 65 for transmitting or receiving the high-frequency signal through an antenna sharing device 64 (duplexer) connected to the high-frequency module 63.

Then, in the high-frequency module 63, the transmission side is constituted by a bandpass filter 66, an amplifier 67, a mixer 68, a bandpass filter 69, and a power amplifier 70 connected between the output side of the signal processing circuit 62 and the antenna sharing device 64, and the reception side is constituted by a bandpass filter 71, a low-noise amplifier 72, a mixer 73, a bandpass filter 74, and an amplifier 75 connected to the antenna sharing device 64 and the input side of the signal processing circuit 62. Then, the oscillator device 76 using a TM010 mode resonator device of the present invention as in the fourth embodiment, for example, is connected to the mixers 68 and 73.

The communication device of the present embodiment has the above construction, and, next, the operation is described.

First, in transmission of a signal, after unnecessary signals in an intermediate signal (IF signal) output from the signal processing circuit 62 have been eliminated in the bandpass filter 66, the intermediate frequency signal is amplified by the amplifier 67 and then input to the mixer 68. At this time, the mixer 68 as an up-converter generates a high-frequency signal (RF signal) by mixing the intermediate frequency signal and a carrier wave from the oscillator device 76. Then, after unnecessary signals in the high-frequency signal output from the mixer 68 has been eliminated in the bandpass filter 69, the high-frequency signal is amplified by the power amplifier 70 and transmitted from the antenna 65 through the antenna sharing device 64.

On the other hand, in reception of a signal, a high-frequency signal received from the antenna 65 is input to the bandpass filter 71 through the antenna sharing device 64. In this way, after unnecessary signals in the high-frequency signal have been removed in the bandpass filter 71, the high-frequency signal is amplified by the low-noise amplifier 72 and input to the mixer 73. At this time, the mixer 73 as a down-converter generates an intermediate frequency signal by mixing the high-frequency signal and a carrier wave from the oscillator device 76. Then, unnecessary signals in the intermediate frequency signal output from the mixer 73 are eliminated in the bandpass filter 74, and the intermediate frequency signal is amplified by the amplifier 75 and then input to the signal processing circuit 62.

Thus, according to the present embodiment, since a communication device is constituted by using the oscillator device 76 having a TM010 mode resonator device of the present invention in which radiation is suppressed, the construction of the oscillator device 76 can be simplified and the manufacturing cost of the total communication device can be reduced.

Moreover, in the fifth embodiment, although the case in which an oscillator device 76 using a TM010 mode resonator device of the present invention is applied to the communication device 61 is described as an example, the oscillation device 76 may be applied to a radar device, etc.

1. A TM010 mode resonator device comprising:
a dielectric substrate;
electrodes formed on opposite surfaces of the dielectric substrate, at least one of the electrodes being a circular electrode; and
a plurality of through holes extending through the dielectric substrate and arranged around the circular electrode on the dielectric substrate, wherein an inside of each through hole does not have an electrode and,
wherein the plurality of through holes are arranged around the circular electrode to form an open-circuited end for improving confinement of an electromagnetic field.

2. The TM010 mode resonator device as claimed in claim 1, wherein, when a wavelength of a resonance frequency in the dielectric substrate is represented by λg, a space between neighboring through holes is λg/4 or less.

3. A TM010 mode resonator device comprising:
a dielectric substrate;
electrodes formed on opposite surfaces of the dielectric substrate, at least one of the electrodes being a circular electrode; and
a plurality of strip electrodes disposed so as to radially extend around the at least one circular electrode formed on the dielectric substrate such that there is a space between circular electrodes or the at least one circular electrode and the plurality of strip electrodes.

4. The TM010 mode resonator device as claimed in claim 3, wherein, when a wavelength of a resonance frequency in the dielectric substrate is represented by λg, a length of the radially extending strip electrode is λg/4 and the strip electrodes are rectangular in shape.

5. The TM010 mode resonator device as claimed in claim 3, wherein a space between neighboring strip electrodes is λg/4 or less.

6. An oscillator device comprising:
a TM010 mode resonator device as claimed in claim 1.

7. A transmission and reception device comprising:
a TM010 mode resonator device as claimed in claim 1.

8. TheTM010 mode resonator device as claimed in claim 4, wherein a space between neighboring strip electrodes is λg/4 or less.

9. An oscillator device comprising:
a TM010 mode resonator device as claimed in claim 3.

10. A transmission and reception device comprising:
a TM010 mode resonator device as claimed in claim 3.
